(19) United States
(12) Patent Application Publication
(10) Pub. No.: US 2016/0177812 A1
(43) Pub. Date: Jun. 23, 2016

(54) METHOD FOR CONTROLLING A TWO-STROKE INTERNAL COMBUSTION ENGINE

(71) Applicant: SOCIETE DE MOTORISATIONS AERONAUTIQUES, Bourges (FR)

(72) Inventors: Guillaume LABEDAN, Paris (FR); Hugues Denis JOUBERT, Paris (FR); Norbert LARTIGUE, Le Plessis Robinson (FR)

(21) Appl. No.: 14/906,996

(22) PCT Filed: Jul. 21, 2014
(86) PCT No.: PCT/FR2014/051877

§ 371 Date: Jan. 22, 2016

(30) Foreign Application Priority Data
Jul. 23, 2013 (FR) 1357218

(51) Int. Cl. F02B 25/22; F02B 75/02; F02B 25/04

(52) U.S. Cl. CPC F02B 25/22; F02B 25/04; F02B 75/02; F02B 2075/025

(57) ABSTRACT

A method for controlling a two-stroke internal combustion engine, the control method including: a longitudinal movement of a piston in the direction of the bottom dead centre of an engine, the movement being triggered by the expansion of burned gases in the master cylinder, during the longitudinal movement of the piston, the process includes a step of intake air pressurisation, adjustment of the pressure of the burned gases to a value lower than the intake air pressure, introduction into the cylinder of pressurised intake air, the air introduced forming a stratification layer redirecting the burned gases in the direction of the exhaust port.

### TECHNICAL FIELD

The present invention relates to a method for controlling a two-stroke internal combustion engine as well as a two-stroke internal combustion engine intended to be controlled in accordance with the control method according to the invention. Such an engine and such a control method may be advantageously implemented in the aeronautics field.

### STATE OF THE PRIOR ART

Two-stroke internal combustion engines of uniflow type are known, such engines comprising:
a master cylinder having a longitudinal axis X,
a piston arranged in the master cylinder, the piston being capable of carrying out a movement along the longitudinal axis X,
an exhaust port located at one end of the master cylinder enabling the exhaust of the burned gases, and
an air intake port in the master cylinder.

Such a two-stroke internal combustion engine is characterised by a power stroke for each turn of crankshaft. The piston that the engine comprises participates solely in the compression and the expansion of the gases contained in the cylinder of the engine, the evacuation of the burned gases and the filling of the master cylinder with air taking place by other mechanisms. More particularly, a compressed air source, at the bottom dead centre of the engine, assures the filling with air of the master cylinder while redirecting simultaneously the burned gases in the direction of the exhaust port. The opening of the exhaust port enables the evacuation of the burned gases.

In order to favour the filling of the master cylinder, it is necessary to create a negative pressure in the master cylinder. However, such a negative pressure increases the rate of inflow of compressed air into the cylinder and generates a phenomenon of blending of compressed air and burned gases. The greater the turbulence in the cylinder, the better the mixing of compressed air and burned gases.

The mixing of introduced air and burned gases leads to, on the one hand, a loss of part of the introduced air to the exhaust without said introduced air participating in the combustion, and on the other hand, a pollution of the introduced air by the burned and hot gases in the cylinder reducing de facto combustion efficiency.

Conventionally, the tuning of the engine consists in assuring the exhaust of the totality of burned gases, which implies in compensation that a part of introduced air, due to the phenomenon of mixing, is lost directly to the exhaust.

### DESCRIPTION OF THE INVENTION

The objective of the invention is thus to overcome the drawbacks of the prior art. In this context, the aim of the present invention is to provide a method for controlling a two-stroke internal combustion engine having optimised combustion efficiency.

To this end, the invention pertains to a method for controlling a two-stroke internal combustion engine, said engine comprising:
a master cylinder having a longitudinal axis X,
a piston arranged in said master cylinder, said piston being capable of carrying out a movement along said longitudinal axis X,
an exhaust port comprising at least one exhaust valve,
an air intake port in said master cylinder, said control method comprising the following steps:
longitudinal movement of said piston in the direction of the bottom dead centre of said engine, said movement being triggered by the expansion of burned gases in said master cylinder, during said longitudinal movement of said piston the method comprises a step of intake air pressurisation,
adjustment of the pressure of said burned gases to a value lower than said intake air pressure,
introduction into said cylinder of pressurised intake air, the air introduced forming a stratification layer redirecting said burned gases in the direction of said exhaust port.

In the remainder of the description stratification layer is taken to mean a layer of air introduced into the cylinder not mixed with burned gases. This layer of air (also known as stratification air layer) only comprises introduced air not mixed with the burned gases that the master cylinder contains.

Thanks to the invention, the intake air is introduced before the opening of the exhaust port, the pressure of the intake air being above the pressure of the burned gases, which makes it possible to stratify the air introduced inside the cylinder. Once the exhaust port is open, the action of the intake air at a slightly higher pressure compared to the burned gas combined with the rising of the piston after bottom dead centre, expels the burned gases while avoiding mixing of the introduced air with the burned gases. Moreover, since there is no mixing, the introduced air is not ejected outside of the master cylinder.

The method for controlling a two-stroke internal combustion engine according to the invention may also have one or more of the following characteristics, considered individually or according to any technically possible combinations thereof.

In a non-limiting embodiment, the adjustment of the pressure of the burned gases to a value lower than said intake air pressure is carried out via the opening of a low flow relief valve.

In a non-limiting embodiment, the method according to the invention comprises a step of closing the relief valve as soon as the burned gases have a pressure lower than the intake air pressure.

In a non-limiting embodiment, as soon as the pressure contained in the cylinder formed by the stratification layer and the burned gases is substantially equal to the value of the intake air pressure, the method comprises a step of opening the exhaust port, the introduction of pressurised intake air into the master cylinder continuing.

In a non-limiting embodiment, the adjustment of the pressure of the burned gases to a value lower than the intake air pressure is carried out by the opening of the exhaust port and the creation of a counter-pressure at the start of said opening of the exhaust port in order to limit the exhaust flow of burned gases. This counter-pressure may be generated by reflection of acoustic waves in the exhaust manifolds (not represented). In reciprocating engines, the exhaust sees gusts of gas passing through which create acoustic waves of positive pressure and negative pressure in the exhaust manifolds. In this particular configuration of the solution, the lengths of the manifolds and positions of the junctions between exhausts from each cylinder are defined so as to reflect a positive pressure at the exhaust port to limit the emptying rate of the gases at the start of the opening thereof.

In a non-limiting embodiment, the method according to the invention comprises a step of closing the exhaust port when the totality of the burned gases is evacuated.

In a non-limiting embodiment, the adjusted pressure of the burned gases is at least 150 mbar lower than the intake air pressure, or for example of the order of 150 mbar.

The invention also pertains to a two-stroke internal combustion engine comprising:
a master cylinder having a longitudinal axis X,
a piston arranged in said master cylinder, said piston being capable of carrying out a movement along said longitudinal axis X,
an exhaust port comprising at least one exhaust valve,
intake air pressurisation means,
at least one pressurised air intake port in said master cylinder. The engine further comprises a pressure regulator suited to adjust the pressure of the burned gases contained in said master cylinder to a value lower than said intake air pressure.

In a non-limiting embodiment, the pressure regulator is formed by a low flow relief valve, the opening of which enables adjustment of the pressure of the burned gases contained in said master cylinder to a value lower than the intake air pressure.

### BRIEF DESCRIPTION OF THE FIGURES

Other characteristics and advantages of the invention will become clear from the description that is given thereof below, for indicative purposes and in no way limiting, with reference to the appended figures, among which:

FIG. 1 illustrates a non-limiting example of embodiment of a two-stroke internal combustion engine according to the invention,

FIG. 2 illustrates a synoptic of the steps of a possible implementation of a method for controlling a two-stroke internal combustion engine according to the invention, and

FIGS. 3A, 3B, 3C and 3D schematically illustrate different steps of the method for controlling a two-stroke internal combustion engine according to the invention detailed with the support of FIG. 2.

For reasons of clarity, only elements useful for the understanding of the invention have been represented, without respect for scale, and in a schematic manner. Moreover, similar elements situated in the different figures comprise identical references.

### DETAILED DESCRIPTION OF AT LEAST ONE EMBODIMENT OF THE INVENTION

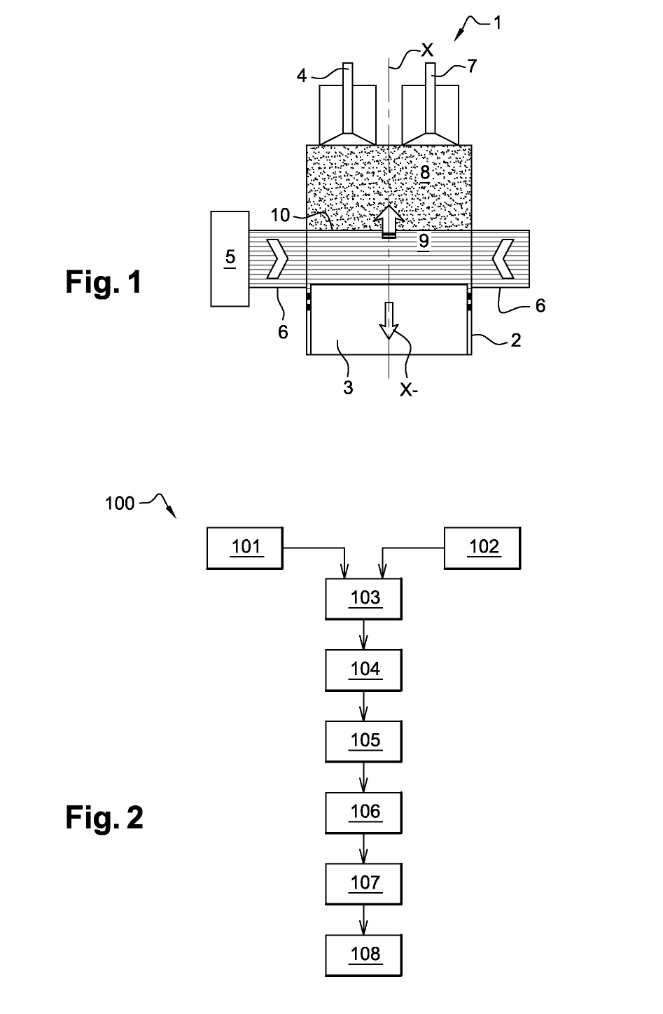

FIG. 1 illustrates a non-limiting example of embodiment of a two-stroke internal combustion engine 1 according to the invention. The two-stroke internal combustion engine 1 illustrated in FIG. 1 comprises:
a master cylinder 2 having a longitudinal axis X,
a piston 3 arranged in the master cylinder 2, the piston 3 being capable of carrying out a back and forward movement in the master cylinder 2 along the longitudinal axis X,
an exhaust port 4 formed by an exhaust valve, the exhaust port 4 being located at the top dead centre of the engine 1,
intake air pressurisation means 5,
two pressurised air intake ports 6 in the master cylinder 2, the two intake ports 6 being situated at the level of the bottom dead centre of the engine 1, and
a pressure regulator 7 (formed by a low flow relief valve) suited to adjust the pressure of the burned gases 8 contained in the master cylinder 2 to a value lower than the intake air pressure. This relief valve 7 is also situated at the top dead centre of the engine 1.

Thus, the two-stroke internal combustion engine 1 according to the invention is provided with two types of valves, the opening of which is sequenced in order to optimise the evacuation rate of the burned gases contained in the master cylinder 2.

In a particularly interesting but non-limiting implementation, the low flow relief valve 7 is opened before the opening of the exhaust valve 4 in order to reduce the difference between the admission pressure and the pressure of the burned gases of the master cylinder 2. This reduction in pressure difference makes it possible to control the inflow rate of intake air into the master cylinder 2.

The two-stroke internal combustion engine 1 illustrated in FIG. 1 comprises a single exhaust valve 4 and a single relief valve 7 but it is understood that the engine 1 according to the invention is not limited to such an embodiment and it may comprise several relief valves 7 and/or several exhaust valves 4.

In another non-illustrated embodiment of the two-stroke internal combustion engine according to the invention, the exhaust port is situated near to the bottom dead centre of the engine and the intake port, for example commanded by a valve, is situated near to the top dead centre of the engine. This embodiment makes it possible to take advantage of the inertia of the burned gases during expansion for the exhaust of said burned gases.

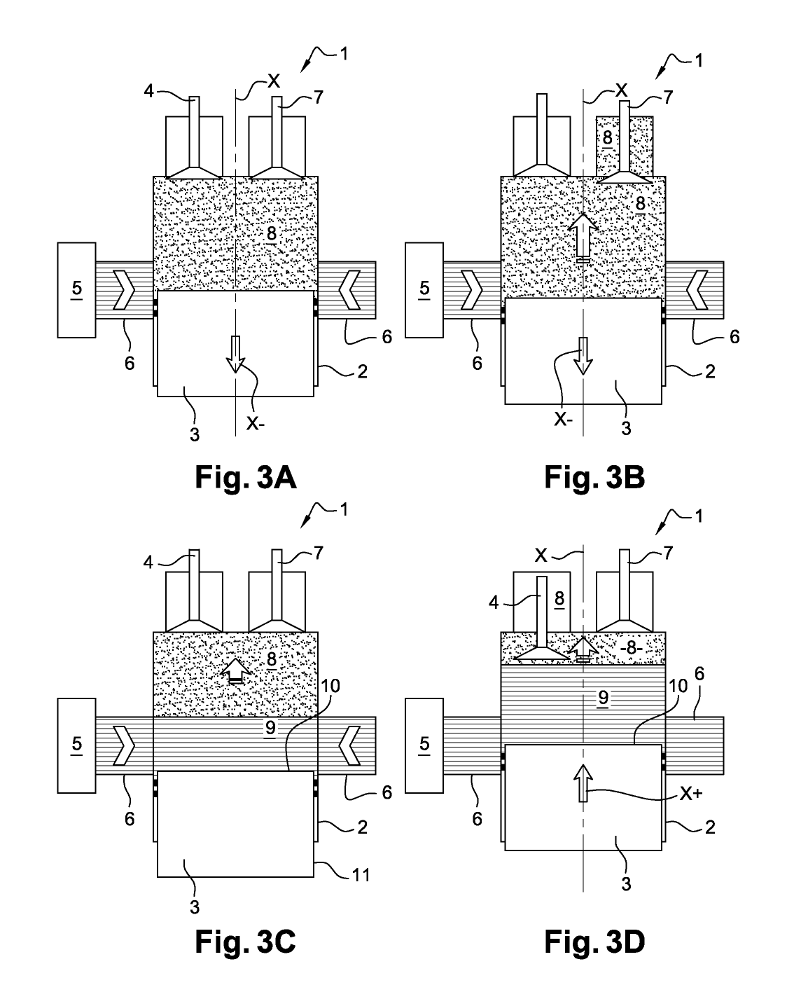

FIG. 2 illustrates a synoptic of the steps of a possible implementation of a method for controlling 100 a two-stroke internal combustion engine 1 according to the invention, and FIGS. 3A, 3B, 3C and 3D schematically illustrate certain steps of the control method 100 according to the invention detailed in support of FIG. 2.

In a non-limiting implementation, the method for controlling 100 a two-stroke internal combustion engine 1 comprises the following steps.

The control method 100 comprises a step of longitudinal movement 101 of the piston 3 in a direction X− opposite to the exhaust port 4 (FIG. 3A), the movement being triggered by the expansion of burned gases in the master cylinder 2 and continuing until the piston 3 unblocks the inlet ports 6.

Simultaneously with the longitudinal movement along the direction X− of the piston 3, the control method 100 comprises a step of intake air pressurisation 102.

The control method 100 comprises an additional step of adjustment 103 of the pressure of the burned gases contained in the master cylinder 2 to a value lower than the pressure of intake air pressurised during the preceding step 102. For example, the adjusted pressure of the burned gases is 150 mbar lower than the intake air pressure. In a non-limiting implementation, the adjustment of the pressure of the burned gases to a value lower than the intake air pressure is carried out via the opening of the low flow relief valve 7 (FIG. 3B). The opening of the relief valve 7 precedes the unblocking of the intake ports 6 by the piston 3.

In a non-limiting implementation, as soon as the burned gases have a pressure lower than the intake air pressure, the closing 104 of the relief valve 7 is triggered.

As soon as the intake ports 6 are unblocked (FIG. 3C) by the piston 3, the control method 100 comprises a step of introduction of pressurised intake air 105 into the master cylinder 2, the air introduced forming a stratification layer 9 covering the top 10 of the piston 3. The stratification layer 9 formed of pressurised intake air forms a layer separating the top 10 of the piston 3 from the burned gases 8. Thus, this stratification layer 9 redirects the burned gases 8 in the direction of the exhaust port 4.

In other words, the piston 3 exposes the intake ports 6 allowing the inflow of intake air to constitute the stratification layer 9. The burned gases 8 are then redirected to the top of the master cylinder 2. Since the exhaust port 4 remains closed during this phase, the cylinder pressure re-establishes itself at the value of the intake air pressure.

As soon as the pressure contained in the master cylinder 2 formed by the stratification layer 9 and the burned gases 8 is substantially equal to the value of the intake air pressure, the control method 100 comprises a step of opening the exhaust port 106 (FIG. 3D), the introduction of pressurised intake air continuing. In our example, in order to open the exhaust port 4, the exhaust valve is opened. The raising of the exhaust valve 4 is suited to make it possible to control the maximum exhaust flow while maintaining the cylinder pressure close to the intake pressure.

Then the control method 100 comprises a step of movement of the piston 107 in the direction X+ of the exhaust port 4 leading to the exhaust of the burned gases 8 via the exhaust valve 4 whereas the master cylinder 2 fills with intake air at the rear of the stratified layer 9, in other words between the top 10 of the piston 2 and the stratified layer 9. Mixing between the introduced air and the burned gases is practically inexistent due to the low speed of movement of said burned gases, the small difference in pressure of said burned gases and the low speed of movement of the piston 3.

In a non-limiting embodiment, the intake ports are formed by inlet openings. Thus, the intake flow during the phase of exhaust of the burned gases may be adapted by the shape of the inlet openings to prevent the gas column, which begins an upward movement in the master cylinder 2, entering into oscillation. In another embodiment of the invention, the inlet openings are oriented so as to supply the cylinder tangentially, giving to the flow a vortex movement (well known as swirl). The expected advantages are better stability of the stratified layer of fresh air during the movement of the piston and greater sturdiness to turbulences, capable of appearing notably at the level of the exhaust valve.

When the totality of the burned gases 8 is evacuated, the control method 100 comprises a step of closing 108 the exhaust valve 4. The movement of the piston 3 in the direction X+ of the exhaust port 4 is continued until the intake ports 6 are sealed off by the piston 3 (FIG. 3D). In this embodiment, the skirt 11 of the piston blocks the intake ports 6 when the piston 3 is at top dead centre. This particularity makes it possible to prevent leakage of fresh air to the engine crankcase. In this embodiment, the piston 3 may comprise a sealing segment at the bottom of the skirt 11 in order to limit the loss of air under pressure to the crankcase. In another non-illustrated embodiment, to limit the loss of air under pressure to the crankcase, the opening and the closing of the intake port 6 may be commanded, for example, by a sliding gate or sleeve valve distribution.

Furthermore, it should be noted that the role of the exhaust valve 4 is to evacuate the greatest part of the burned gases 8, while controlling the exhaust rate of the burned gases 8 throughout the sweeping of the piston. This makes it possible to limit the part of air introduced to the exhaust and to limit turbulence and thus mixing between the introduced air and the burned gases. This exhaust valve is defined to limit the distortion of the velocity field of the burned gases in the exhaust zone, and thus avoid perturbing the layer of stratified air created on the head of the piston.

The method as well as the engine according to the invention advantageously enable:
an improvement of engine efficiency, in fact:
   The quasi-inexistence of mixing between the introduced air and the burned gases makes it possible to limit the residual part of burned gases at each engine cycle. Consequently, the proportion of oxygen available is higher making it possible to increase the pressure and the engine cycle temperature, and consequently its efficiency,
   The invention makes it possible to reduce the dilution of the exhaust gases by air introduced during the engine cycle. The temperature of the exhaust gases is thus higher than in a conventional engine, which makes it possible to increase the part of energy recoverable at the exhaust on a turbine for example.
an increase in the specific power:
   A smaller proportion of introduced air (thus oxidant) is lost directly to the exhaust, which makes it possible to reduce the need for air of the engine, and thus the engine capacity,
   The solution requires the use of an air pressurisation, typically realised by a compressor driven by the crankshaft or a turbo-compressor. The supercharging makes it possible to increase the masses of air and fuel at each cycle, thus the power/engine capacity ratio.

1. A method for controlling a two-stroke internal combustion engine, said engine comprising
a master cylinder having a longitudinal axis,
a piston arranged in said master cylinder, said piston being capable of carrying out a movement along said longitudinal axis,
an exhaust port for burned gases,
an air intake port in said master cylinder,
said control method comprising
longitudinally moving said piston in the direction of a bottom dead centre of said engine, said longitudinal movement being triggered by expansion of burned gases in said master cylinder, wherein during said longitudinal movement of said piston the method comprises a step of intake air pressurisation,
adjusting a pressure of said burned gases to a value lower than said intake air pressure,
introducing into said master cylinder of pressurised intake air, the exhaust port remaining closed during said introducing, the air introduced forming a stratification layer redirecting said burned gases in a direction of said exhaust port.

2. The method according to claim 1, wherein the adjustment of the pressure of said burned gases to a value lower than said intake air pressure is carried out via an opening of a low flow relief valve.

3. The method according to claim 2, further comprising closing the low flow relief valve as soon as the burned gases have a pressure lower than the intake air pressure.

4. The method according to claim 1, wherein as soon as the pressure contained in said master cylinder formed by the stratification layer and the burned gases is substantially equal to the value of the intake air pressure, the method comprises a step of opening the exhaust port, the introduction of pressurised intake air into the master cylinder continuing.

5. The method according to claim 1, wherein the adjustment of the pressure of the burned gases to a value lower than the intake air pressure is carried out by the opening of the exhaust port and the creation of a counter-pressure at the start of said opening of the exhaust port in order to limit the exhaust flow of the burned gases.

6. The method according to claim 1, further comprising closing the exhaust port when the totality of the burned gases has been exhausted from the master cylinder.

7. The method according to claim 1, wherein the adjusted pressure of the burned gases is of the order of 150 mbar lower than the intake air pressure.

8. A two-stroke internal combustion engine comprising:
a master cylinder having a longitudinal axis X;
a piston arranged in said master cylinder, said piston being capable of carrying out a movement along said longitudinal axis X;
an exhaust port for burned gases;
an intake air pressurizer;
an intake port for pressurised air in said master cylinder, and a low flow relief valve, wherein opening of the intake port enables the adjustment of a pressure of the burned gases contained in said master cylinder to a value lower than the intake air pressure.
